(19) United States
(12) Patent Application Publication
(10) Pub. No.: US 2005/0226000 A1
(43) Pub. Date: Oct. 13, 2005

(54) Optical apparatus for illuminating an object

(75) Inventors: Dieter Bader, Obergroningen (DE); Norbert Reng, Heidenheim (DE); Johannes Wangler, Koenigsbronn (DE)

Correspondence Address: FISH & RICHARDSON PC, P.O. BOX 1022, MINNEAPOLIS, MN, 55440-1022, US

(73) Assignee: Carl Zeiss SMT AG, Oberkochen (DE)

(21) Appl. No.: 11/017,375

(22) Filed: Dec. 20, 2004

Related U.S. Application Data
(63) Continuation of application No. PCT/EP03/06397, filed on Jun. 18, 2003.

(30) Foreign Application Priority Data
Jul. 8, 2002 (DE) 102 30 652.4

(51) Int. Cl. F21V 7/04

(52) U.S. Cl. 362/554

(57) ABSTRACT

An optical apparatus for illuminating an object, for example an illumination system of a microlithographic exposure system, comprises a light source that generates a plurality of individual bundles that constitute an illumination bundle. A control device controls the light source in such a way that a desired form of the illumination bundle is determined by selecting an appropriate set of individual bundles.

### CROSS-REFERENCE TO RELATED APPLICATIONS

This application is a continuation (and claims the benefit of priority under 35 U.S.C. §120) of international application number PCT/EP2003/006397, filed Jun. 18, 2003 which claims priority to German application number 102 30 652.4, filed Jul. 8, 2002. The disclosure of the prior applications are considered part of (and is incorporated by reference in) the disclosure of this application.

### BACKGROUND OF THE INVENTION

1. Field of the Invention

The present invention relates generally to an optical apparatus for illuminating an object. More particularly, the invention relates to illumination systems used in microlithographic exposure apparatuses. Such apparatuses are suitable for microlithographic chip manufacture or for the production of flat display screens, for example.

2. Description of Related Art

U.S. Pat. No. 5,091,744 A discloses an illumination system of a projection exposure apparatus in which a plurality of individual light bundles form a projection light bundle which in itself is incoherent and in which undesirable interference effects are reduced. This known illumination system does not allow to realize exacting illuminations that approach the resolution that can be achieved with the optical exposure wavelength.

### SUMMARY OF THE INVENTION

It is an object of the present invention to provide an optical apparatus for illuminating an object that shall be imaged by a subsequent optical system with very high requirements in terms of resolution.

According to the invention, this object is achieved by an optical apparatus comprising:
a light source that generates a plurality of individual bundles that constitute an illumination bundle, and
a control device that controls the light source in such a way that a desired form of the illumination bundle is determined by selecting an appropriate set of individual bundles.

In the following, the term ‘illumination setting’ shall denote the intensity distribution of the illumination bundle in a pupil plane of the optical apparatus.

In the following, the term ‘exposure cycle’ denotes the period of time between the start and the end of step in which a given object is illuminated. Depending upon the illumination technology being used, several illumination steps may be needed.

In the following, ‘illumination light’ denotes illumination light with wavelengths in the visible, infrared or ultraviolet wavelength region, for which, in particular, transmissive optical components are also available.

By means of the control device it is possible to quickly and variably adjust different illumination settings that are adapted to the respective imaging requirements. The illumination setting may be changed during the illumination process in a manner depending on the structure of the illuminated object. For example, in microlithography a pole-balance correction of the illumination setting, for example a symmetrization of a quadrupole distribution, is possible during the sequence of operations in an exposure process.

Although it is known, in the context of illumination systems of microlithographic exposure apparatuses, to use different illumination settings, hitherto this has been effected with the aid of aperture diaphragms which are arranged interchangeably in interchange holders. The use of diaphragms of such a type necessarily results in a loss of efficiency of the illumination, since light generated by a light source is absorbed by the diaphragm. Apart from that, this absorbed light heats up the diaphragm which is generally an undesired effect. With the optical apparatus according to the invention, the illumination bundle is generated at least substantially in the desired form. This increases the efficiency of the illumination system and reduces the heating of optical components.

If the individual light sources are arranged in a matrix configuration, it is possible to realize different illumination settings particularly easily by selectively activating individual light sources. The more individual light sources are provided, the better will be, at least in general, the approximation of the form of the illumination bundle.

According to another embodiment, the individual light sources are arranged along a first direction. The light source comprises a scanning device that, for generating the illumination bundle, deflects in a controlled manner the individual bundles during an exposure cycle in a second direction. This second direction is perpendicular to the first direction and to a propagation direction along which light generated by the light sources propagates. Such a light source is constructed more simply than a two-dimensional light-source matrix. The desired illumination setting can be obtained here by a controlling the individual light sources synchronized with the deflection.

According to still another embodiment, the light source comprises one single individual light source and a scanning device. The latter deflects in a controlled manner the individual bundles during an exposure cycle in two directions perpendicular to one another and to a propagation direction along which light generated by the light sources propagates. The desired illumination setting here is a result of a synchronized superposition of line scanning and column scanning similar the synthesis of a television picture.

The use of a laser diode as individual light source or as light source for a scanning device has the advantage that a long service life may be achieved. In addition, laser diodes produce a comparatively small amount of heat due to their high efficiency. Laser diodes can therefore also be combined to form closely adjacent groups, for example matrix arrangements.

If very high luminous powers are required, a solid-state laser may be used as light source.

If the light source is positioned close to or in a pupil plane of the illumination system of a microlithographic exposure system, an optimized illumination setting can be ensured. No light losses have to be put up with that conventionally are caused by filters or diaphragms that are arranged in the region of the pupil plane.

A filter that is arranged downstream of the light source and narrows the spectral bandwidth of the light source enhances the spectral purity of the illumination bundle and thus further improves the imaging properties.

### BRIEF DESCRIPTION OF THE DRAWINGS

Various features and advantages of the present invention may be more readily understood with reference to the following detailed description taken in conjunction with the accompanying drawing in which:

FIG. 1 shows a schematic view of a prior art illumination system of a projection exposure apparatus;

FIG. 2 shows a portion of an illumination system of a projection exposure apparatus with a light source according to the invention;

FIG. 3 shows an enlarged top view of a light source similar to FIG. 2;

FIGS. 4 to 7 show the light source of FIG. 3 in different operation conditions for obtaining different illumination settings;

FIGS. 8 and 9 show top vies of alternative light sources according to the invention;

FIG. 10 shows an instrument for wafer inspection.

### DESCRIPTION OF PREFERRED EMBODIMENTS

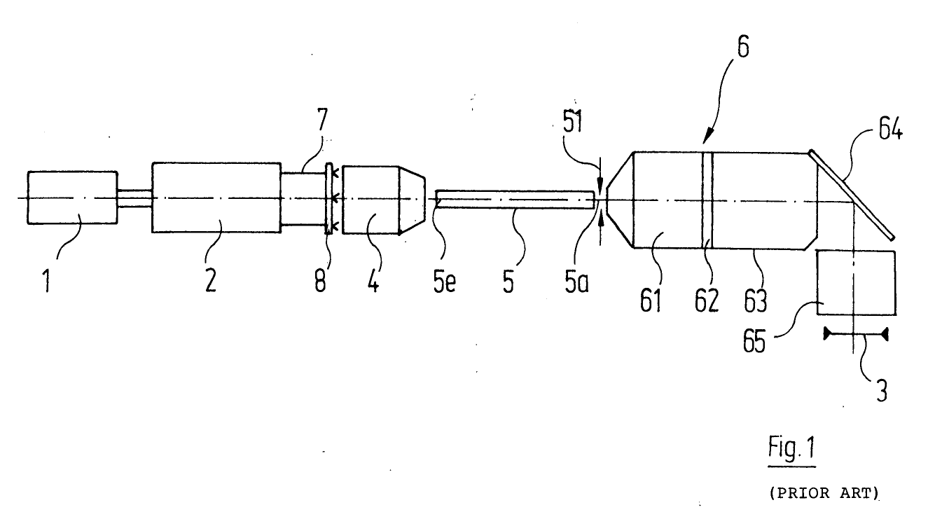

FIG. 1 shows a prior art illumination system for a projection exposure apparatus. The illumination system presets and forms a projection light bundle that illuminates a reticle 3. The reticle 3 contains an original structure which projected onto a wafer by means of projection optics (not shown in FIG. 1).

A laser 1 is used as source for projection light. It generates a projection light bundle 7 which is represented in FIG. 1 in certain regions only. The projection light bundle 7 is firstly expanded in the optical path downstream of the laser 1 by means of a zoom objective 2. Subsequently the projection light bundle 7 passes through a diffractive optical element 8 and an objective 4 which directs the projection light bundle 7 onto an entrance face 5e of a glass rod 5. The latter mixes and homogenizes the projection light bundle 7 as a result of multiple internal reflections. Located in the region of the exit face 5a of the glass rod 5 is a field plane of the illumination system in which a reticle-masking system (REMA) is arranged. The latter is constituted by an adjustable field stop 51.

After passing through the field stop 51, the projection light bundle 7 propagates through a further objective 6 with lens groups 61, 63, 65, reflecting mirror 64 and a pupil plane 62. The objective 6 images the field plane of the field stop 51 onto the reticle 3.

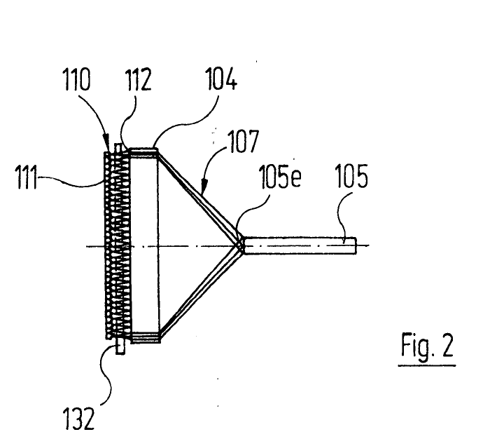

FIG. 2 shows a light source 110 according to the invention, which replaces the laser 1, the zoom objective 2 and also the diffractive optical element 8 of the construction shown in FIG. 1. The remaining components correspond to those of the illumination system shown in FIG. 1 and are therefore not shown again. In the Figures described below components that correspond to those which have already been described with reference to an earlier Figure are denoted by reference numerals that are augmented by 100 in each case and will not be described again in detail.

The light source 110 is arranged in a pupil plane of the illumination optics and comprises a plurality of UV laser diodes 111 arranged in the manner of a matrix, i.e. in a two-dimensional grid. The number of laser diodes 111 should amount to at least 225, but should preferably be between about 500 and 1000. Each of the UV laser diodes 111 emits an individual light bundle 112 with a mean wavelength of 375 nm and with a mean power of a few mW. The individual light bundles 112 have a divergence of about 10°.

An objective 104 transfers the individual light bundles 112 onto the entrance face 105e of the glass rod 105 in which the projection light bundle 107 composed of the individual light bundles 112 is homogenized. The objective 104 may be a conventional objective or a microlens array. The glass rod 105 and also the subsequent components of the illumination system correspond to the prior art illumination system shown in FIG. 1.

Within the objective 104 and the air space between the objective 104 and the entrance face 105e of the glass rod 105 only the light paths of marginal rays of the outermost individual light bundles 112 are represented in FIG. 2 for reasons of clarity.

For narrowing the spectral bandwidth of the UV laser diodes, an interference filter 132, which is indicated by dashed lines in FIG. 2, may be arranged between the light source 110 and the objective 104.

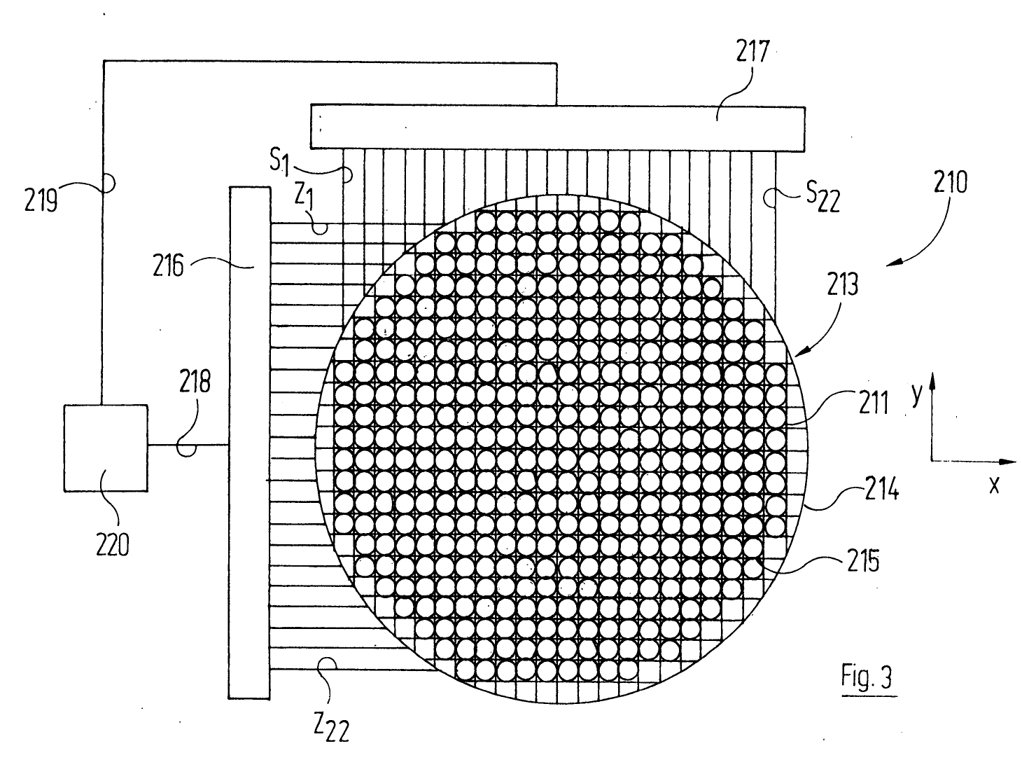

FIG. 3 shows a top view of a light source 210 which, except for the fact that it has a smaller number of UV laser diodes 211 compared with the light source 110 of FIG. 2, corresponds to the light source 110 of FIG. 2.

The UV laser diodes 211 are retained in a grid-like retaining frame 213 which has a circular circumferential surface 214. Within the latter the retaining frame has a plurality of square retaining sockets 215 of equal size that each receives a UV laser diode 211.

The grid-like structure of the retaining sockets 215 defines a matrix-type arrangement of the UV laser diodes 211, which is enclosed by the circumferential surface 214. The laser-diode matrix can be subdivided into a total of 22 lines, which extend in the x-direction of the Cartesian coordinate system according to FIG. 3, and 22 columns, which extend in the y-direction. Owing to the circular boundary, the lines and columns at the edges each comprise only eight UV laser diodes 211, whereas the eight central lines and columns each comprise 22 UV laser diodes 211. The light source 210 comprises a total of 392 UV laser diodes.

Each of the lines is connected to a line multiplexer 216 via a line control wire Zᵢ (i=1, 2, . . . 22). In corresponding manner the columns of the matrix are connected to a column multiplexer 217 via column control wires Sᵢ (i=1, 2, . . . 22). Via control wires 218, 219 the line multiplexer 216 and the column multiplexer 217 are connected to a control device 220.

In the following the use of the light sources 110, 210 will be described with reference to the light source 210.

Depending upon the imaging requirement that are determined by the structure contained in the reticle 3, an appropriate illumination setting is adjusted with the aid of the control device 220. Depending upon the illumination setting, different groups of UV laser diodes 211 are activated for the purpose of emitting UV light. In this process a UV laser diode 211 is activated by simultaneous energizing a pair of control wires Zᵢ and Sⱼ that correspond to the matrix position (line i, column j) of the UV laser diode 211.

In the simplest case, all UV laser diodes 211 are activated so that the pupil plane of the illumination optics is filled completely with UV light.

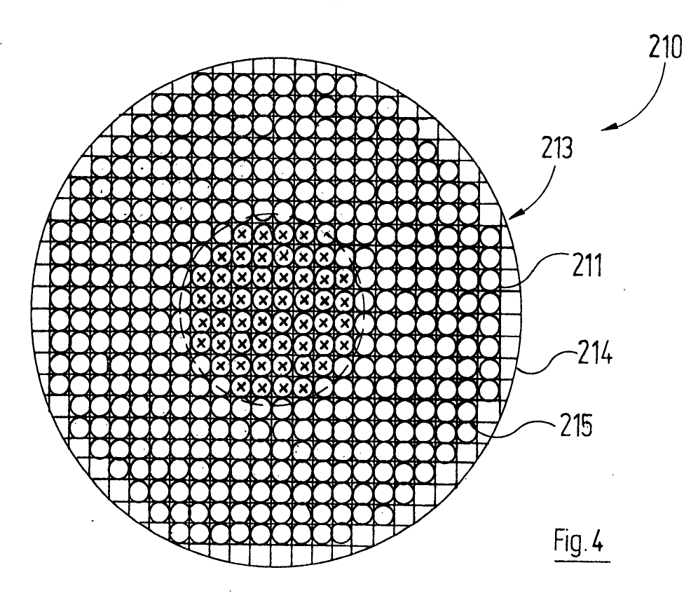

Other illumination settings will be described in the following with reference to FIGS. 4 to 7 that show the light source 210 without the control device 220 and the multiplexers 216, 217.

FIG. 4 shows an illumination setting in which the central line control wires Z₈ to Z₁₅ and also the central column control wires S₈ to S₁₅ are selectively energized in such a way that a group of UV laser diodes 211 is activated within a central region of the retaining frame 213 which is indicated in FIG. 4 by a dashed circle. An activation of a UV laser diodes 211 is indicated in theses Figures by a cross.

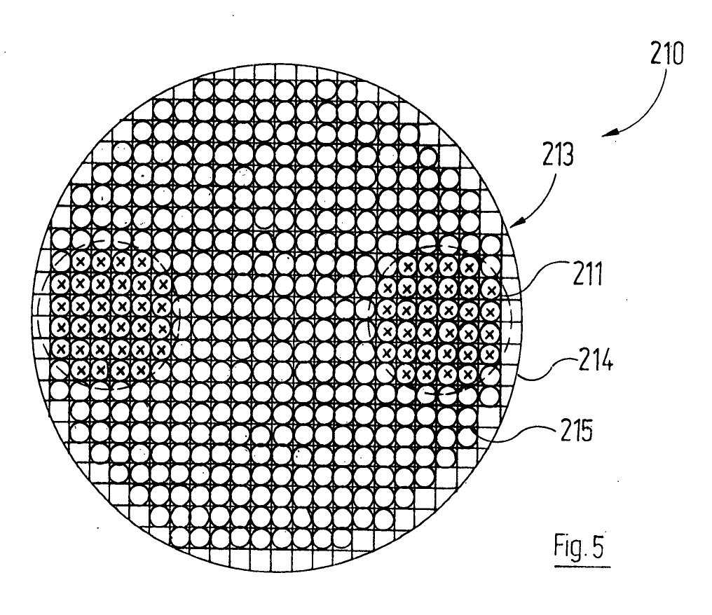

FIG. 5 shows an illumination setting which is commonly referred to as dipole illumination. Here the line control wires Z₉ to Z₁₄ and also the column control wires S₁ to S₆ and also S₁₇ to S₂₂ are energized in such a way that two groups of UV laser diodes 211 are activated that lie within regions which are indicated in FIG. 5 by two dashed circular boundary lines.

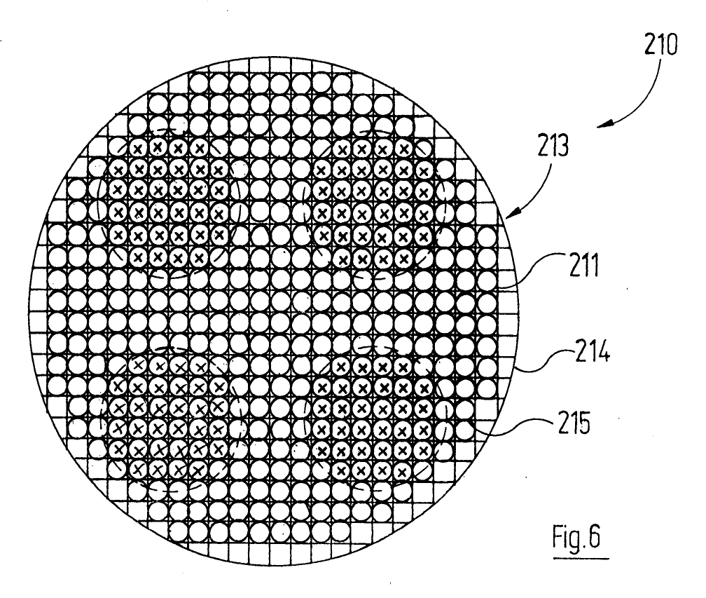

FIG. 6 shows another illumination setting which is commonly referred to as quadrupole illumination. Here the line control wires Z₄ to Z₉ and Z₁₄ to Z₁₉ and also the column control wires S₄ to S₉ and S₁₄ to S₁₉ are energized in such a way that four groups of UV laser diodes 211 are activated that lie within four regions which are indicated in Figure 6 by circular dashed lines.

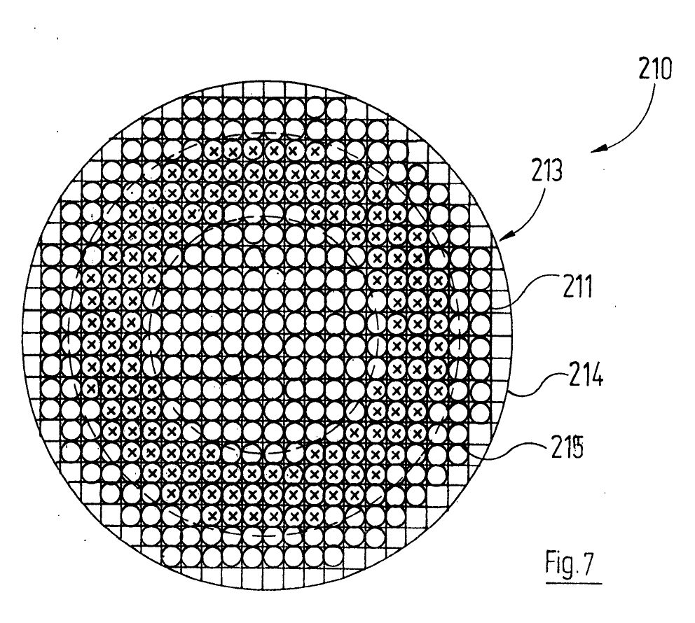

FIG. 7 shows a still further illumination setting which is commonly referred to as annular illumination. Here the line control wires Z₃ to Z₂₀ and also the column control wires S₃ to S₂₀ are energized in such a way that the UV laser diodes 211 are activated within an annular region which is indicated in FIG. 7 by two concentric dashed circles.

Depending upon the illumination requirements of the structure contained in the reticle 3, the illumination settings described above and virtually any others can be adjusted by appropriately activating the laser diodes 211 via the control device 220. In particular, the radii of the activated regions in the case of the illumination settings according to FIGS. 4 to 7 and also the position of the centers of the activated regions in the case of the illumination settings of FIG. 5 (dipole) and FIG. 6 (quadrupole) and the shape and the number of the activated regions can be determined in accordance with the imaging requirements.

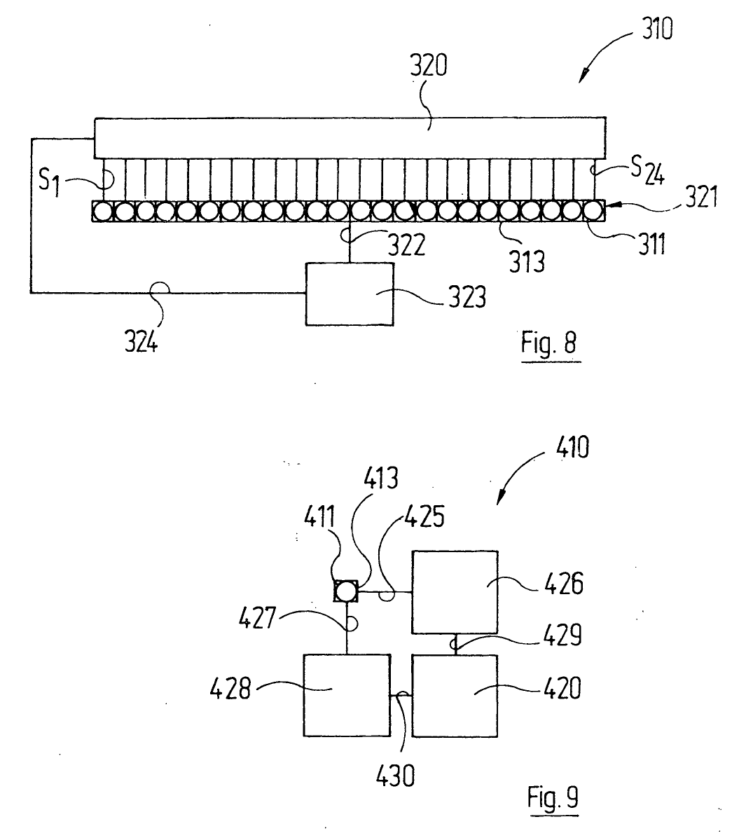

FIGS. 8 and 9 show top views of further embodiments of light sources according to the invention. In the top views the propagation direction of the UV laser diodes is perpendicular to the plane of the drawing, i.e. pointing towards the observer.

The light source 310 of FIG. 8 comprises a line 321 of twenty-four UV laser diodes 311 retained in a linear retaining frame 313. The UV laser diodes 311 are each connected to a control device 320 via control wires Sᵢ (i=1, 2, . . . 24). Via a mechanical coupling 322 which is represented only schematically in FIG. 8, the line 321 is connected to an actuator 323 which in turn is connected to the control device 320 via a control wire 324. With the aid of the actuator 323 it is possible for the laser-diode line 321 to be swivelled, within a predetermined angular range, about an axis coinciding with the line axis.

The light source 310 works in the following way:

Depending upon the desired illumination setting, the control device 320 energizes the control wires Sᵢ and also 324 in a synchronized manner in such a way that the desired illumination setting of the projection light bundle is obtained as a result of the superposition of a fixed-frequency swivelling motion of the laser-diode line 321 about its longitudinal axis with the energizing of the control wires Sᵢ which is synchronized herewith during an exposure cycle.

An exposure cycle has a duration that corresponds to at least one full period of the swivelling motion of the laser-diode line 321. By virtue of an appropriate synchronized activation by means of the control device 320, with the light source 310 within such a projection cycle it is likewise possible for the illumination settings to be generated that were described above with reference to the layout according to FIG. 3.

The light source 410 of FIG. 9 has a single UV laser diode 411 that is arranged in a retaining frame 413. Via a mechanical coupling 425 the UV laser diode 411 is connected to a column-scanning device 426. A mechanical coupling 427 connects the UV laser diode 411 to a line-scanning device 428. Via control wires 429, 430 the scanning devices 426, 428 are connected to the control device 420.

As a result of the mechanical coupling 425, the UV laser diode 411 is capable of being swivelled, within a predetermined angular range, about an axis that runs vertically in the plane of the drawing of FIG. 9. As a result of the mechanical coupling 427, the UV laser diode 411 is capable of being swivelled, within a predetermined angular range, about an axis that runs horizontally in the plane of the drawing of FIG. 9.

The light source 410 works in the following way:

Depending upon the desired illumination setting, the control device 420 controls the scanning devices 426, 428 via the control wires 429 and 430 in a synchronized manner. As a result of the superposition of the fixed-frequency swivelling motions of the mechanical couplings 425, 427 about the two swivel axes and the synchronized activation of the UV laser diode 411 during a projection cycle, it is possible, in a manner analogous to that described above, to selectively activate a plurality of sequentially generated individual light bundles that seem to be arranged in the manner of a matrix. Via this controlled selection of the individual light bundles which have been generated with the instantaneous orientation of the UV laser diode 411, the desired illumination setting of the projection light bundle is obtained.

A projection cycle in this context connection has a duration that corresponds to at least the lowest common multiple of the full periods of the swivelling motions of the scanning devices 426, 428. By virtue of appropriate synchronized activation by means of the control device 420, it is likewise possible to generate the illumination settings that were described above with reference to the embodiment shown in FIG. 3.

Depending upon the embodiment of the invention, other light sources, optionally coupled with optical waveguides, may be used as an alternative to UV laser diodes. In this context a frequency-multiplied solid-state laser such as a frequency-tripled or frequency-quadrupled Q-switched or mode-locked Nd:YAG laser is envisaged, for example.

Instead of the glass rod described above, a microlens array may also be employed for the purpose of homogenizing the illumination light, as is known in the art as such.

With a view to achieving a better packaging density, the individual light sources may also be arranged in a honeycomb-like structure or in a ring structure.

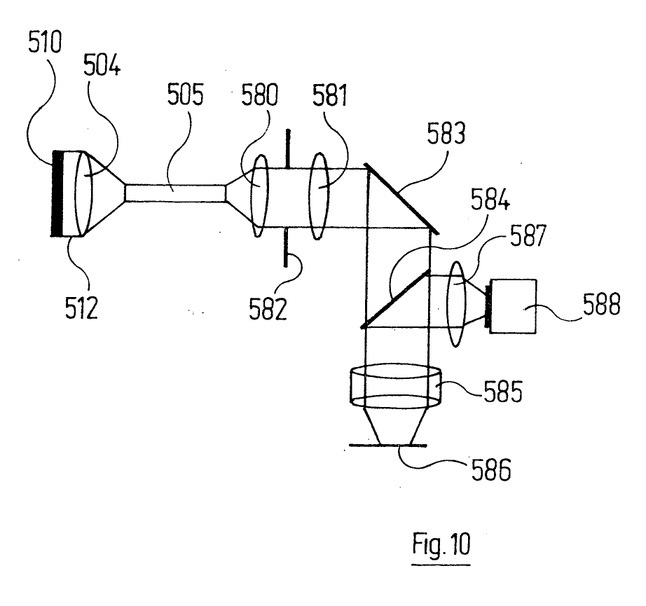

FIG. 10 shows, as another example of an optical apparatus according to the invention, an instrument that is used in microlithography in the course of the production of semiconductor components for the purpose of inspecting the produced wafers. Said instrument comprises a diode array 510 as a light source which generates an illumination bundle 512 composed of a plurality of individual light bundles. A lens 504 couples these illumination bundles 512 into a homogenizing glass rod 505. The light emerging from the glass rod 505 is parallellized with the aid of two condenser lenses 580, 581 having a diaphragm 582 in between. Via a reflecting mirror 583 and a partially transmitting mirror 584 and through a microscope objective 585, the light reaches the wafer 586 that is to be illuminated for inspection.

The light emanating from the wafer 586 passes through the microscope objective 585 in the opposite direction and is coupled out of the optical path of the illumination light with the aid of the partially transmitting mirror 584. The light is then imaged onto a CCD array 588 with the aid of a lens 587. The image generated by this array can then be evaluated visually or automatically.

Once again, by virtue of the use of the diode array 510, it is possible to alter the illumination setting very quickly by selectively activating the individual diodes and to adapt the illumination setting to different structures that shall be resolved on the inspected wafer 586.

Above the invention has been described with reference to optical systems used in the context of microlithography. However, the invention may also be used in all types of optical apparatus in which an object has to be illuminated with different illumination settings for improving the imaging the object.

1. An optical apparatus for illuminating an object, comprising:
a light source that generates a plurality of individual bundles that constitute an illumination bundle, and
a control device that controls the light source in such a way that a desired form of the illumination bundle is determined by selecting an appropriate set of individual bundles.

2. The apparatus of claim 1, wherein the light source comprises a plurality of individual light sources that each are capable of generating one of the individual bundles.

3. The apparatus of claim 2, wherein the individual light sources are arranged in a matrix configuration.

4. The apparatus of claim 3, comprising more than 225 individual light sources.

5. The apparatus of claim 4, comprising more than 500 individual light sources.

6. The apparatus of claim 2, wherein the individual light sources are arranged along a first direction, and wherein the light source comprises a scanning device that, for generating the illumination bundle, deflects in a controlled manner the individual bundles during an exposure cycle in a second direction that is perpendicular to the first direction and to a propagation direction along which light generated by the light sources propagates.

7. The apparatus of claim 1, wherein the light source comprises one single individual light source and a scanning device that, for generating the illumination bundle, deflects in a controlled manner the individual bundles during an exposure cycle in two directions perpendicular to one another and to a propagation direction along which light generated by the light sources propagates.

8. The apparatus of claim 1, wherein the light source comprises a laser diode.

9. The apparatus of claim 1, wherein the light source comprises a frequency-multiplied solid-state laser.

10. An illumination system of a projection exposure apparatus comprising:
a light source that generates a plurality of individual bundles that constitute an illumination bundle, and
a control device that controls the light source in such a way that a desired form of the illumination bundle is determined by selecting an appropriate set of individual bundles.

11. The illumination system of claim 10, wherein the light source is arranged close to or in a pupil plane of the illumination system.

12. The illumination system of claim 10, comprising a homogenizing device that is arranged downstream of the light source for homogenizing an intensity distribution of the illumination bundle.

13. The illumination system of claim 12, wherein the homogenizing device is a glass rod.

14. The illumination system of claim 12, wherein the homogenizing device is a microlens array.

15. The illumination system of claim 10, comprising a filter arranged downstream of the light source that narrows the spectral bandwidth of the light source.

16. A projection exposure apparatus comprising the illumination system of claim 10 and a projection lens that forms an image of an original which is illuminated by the illumination system.

17. The projection exposure apparatus of claim 16, wherein the original is a reticle containing structures to be imaged onto a wafer.

18. An instrument for wafer inspection comprising the optical apparatus of claim 1.
